(19) United States
(12) Patent Application Publication
(10) Pub. No.: US 2015/0263853 A1
(43) Pub. Date: Sep. 17, 2015

(54) ENCRYPTION KEY DISTRIBUTION SYSTEM AND METHOD

(71) Applicants: Elias Eliceo GONZALEZ, Houston, TX (US); Laszlo B. KISH, College Station, TX (US); Robert S. BALOG, College Station, TX (US)

(72) Inventors: Elias Eliceo GONZALEZ, Houston, TX (US); Laszlo B. KISH, College Station, TX (US); Robert S. BALOG, College Station, TX (US)

(73) Assignee: THE TEXAS A&M UNIVERSITY SYSTEM, College Station, TX (US)

(21) Appl. No.: 14/489,025

(22) Filed: Sep. 17, 2014

Related U.S. Application Data
(60) Provisional application No. 61/951,072, filed on Mar. 11, 2014.

(51) Int. Cl. H04L 9/08; G05F 1/66

(52) U.S. Cl. CPC H04L 9/0819; G05F 1/66; H04L 2209/24

(57) ABSTRACT

Systems and methods for the secure distribution of encryption keys in a network are provided. A Kirchhoff-Law-Johnson-(like)-Noise (KLJN) secure key exchange protocol can be utilized in a network where keys are exchanged between hosts connected by a wire. Such a KLJN secure key exchange protocol provides information security that is information theoretically secure.

### CROSS-REFERENCE TO RELATED APPLICATION

The present application claims the benefit of U.S. Provisional Application Ser. No. 61/951,072 filed Mar. 11, 2014, which is hereby incorporated by reference herein in its entirety, including any figures, tables, and drawings.

### BACKGROUND

Cybersecurity is a very important aspect of signal transfer, and an urgent need exists to protect intelligence, companies, infrastructure, and personal data in an efficient way. Encryption keys can be used to transfer data between two hosts over a network, but the key itself must also be transmitted over the network to provide it from one host to another with any reasonable speed. However, transfer of such a key over a network makes the key potentially vulnerable to an attack by a third party monitoring the network.

### BRIEF SUMMARY

Embodiments of the subject invention provide systems and methods for the secure distribution of keys (e.g., encryption keys) in a network and/or a data communication channel. In many embodiments, a Kirchhoff-Law-Johnson-(like)-Noise (KLJN) secure key exchange protocol is utilized. Systems and methods of the subject invention can be utilized in any network where data is exchanged between elements (e.g., hosts) and where such elements are connected by at least one wire capable of transmitting electrical current. A KLJN secure key exchange protocol according to embodiments of the subject invention provides information security that is information theoretically secure.

In an embodiment, a KLJN system for secure key distribution can include: a wired network; and a plurality of hosts connected to each other on the wired network, wherein each host is connected to every other host by a continuous wired path capable of transmitting electrical current. Each host of the plurality of hosts can include a first resistor and can be configured to produce a first-resistor enhanced Johnson noise voltage (“first-resistor” is used as a label only) when the first resistor is connected to a voltage source, and each host of the plurality of hosts can further include a second resistor and can be further configured to produce a second-resistor enhanced Johnson noise voltage (“second-resistor is used as a label only) when the second resistor is connected to a voltage source. The resistance value of the first resistor of each host can be identical to that of all other hosts of the plurality of hosts, and the resistance value of the second resistor of each host can be identical to that of all other hosts of the plurality of hosts. In a further embodiment, the plurality of hosts can include at least three hosts.

In another embodiment, a KLJN method for secure key distribution can include using a system as described in the previous paragraph. The method can include: connecting, to a voltage source, exactly one of the first resistor or the second resistor of a first host of the plurality of hosts, thereby producing a first-host enhanced Johnson noise voltage, which is transmitted to a second host of the plurality of hosts; and connecting, to a voltage source, exactly one of the first resistor or the second resistor of the second host, thereby producing a second-host enhanced Johnson noise voltage, which is transmitted to the first host. In a further embodiment, the method can further include connecting, to a voltage source, exactly one of the first resistor or the second resistor of a third host of the plurality of hosts, thereby producing a third-host enhanced Johnson noise voltage, which is transmitted to the first host.

### BRIEF DESCRIPTION OF THE DRAWINGS

FIG. 1 shows a schematic view of a secure key exchange system according to an embodiment of the subject invention.

FIG. 2 shows a schematic view of a secure key exchange system according to an embodiment of the subject invention.

FIG. 3 shows a schematic view of a filter box of a secure key exchange system according to an embodiment of the subject invention.

FIG. 4 shows a schematic view of a secure key exchange system according to an embodiment of the subject invention.

FIG. 5 shows a schematic view of a filter box of a secure key exchange system according to an embodiment of the subject invention.

FIG. 6 shows a schematic view of a filter box of a secure key exchange system according to an embodiment of the subject invention.

FIG. 7 shows a schematic view of a secure key exchange system according to an embodiment of the subject invention.

FIG. 8 shows a schematic view of a secure key exchange system according to an embodiment of the subject invention.

FIG. 9 shows a schematic view of a secure key exchange system according to an embodiment of the subject invention.

FIG. 10 shows a schematic view of a secure key exchange system according to an embodiment of the subject invention.

FIG. 11 shows a schematic view of a secure key exchange system according to an embodiment of the subject invention.

FIG. 12 shows a schematic view of a secure key exchange system according to an embodiment of the subject invention.

FIG. 13 shows a schematic view of a secure key exchange system according to an embodiment of the subject invention.

FIG. 14 shows a schematic view of a secure key exchange system according to an embodiment of the subject invention.

FIG. 15 shows a schematic view of a secure key exchange system according to an embodiment of the subject invention.

FIG. 16 shows a schematic view of a secure key exchange system according to an embodiment of the subject invention.

FIG. 17 shows a schematic view of a secure key exchange system according to an embodiment of the subject invention.

FIG. 18 shows a schematic view of a secure key exchange system according to an embodiment of the subject invention.

FIG. 19 shows a schematic view of a secure key exchange system according to an embodiment of the subject invention.

FIG. 20 shows a schematic view of a secure key exchange system according to an embodiment of the subject invention.

FIG. 21 shows a schematic view of a secure key exchange system according to an embodiment of the subject invention.

FIG. 22 shows a schematic view of a secure key exchange system according to an embodiment of the subject invention.

FIG. 23 shows a schematic view of a scheme devised to illustrate a Bergou-Scheuer-Yariv (BSY) attack and a Second-Law-attack.

FIG. 24 shows a schematic view of measurements during a Second-Law-attack.

FIG. 25 shows a schematic view of the elimination of a Second-Law-attack and a BSY-attack by introduction of a proper temperature offset.

### DETAILED DISCLOSURE

Embodiments of the subject invention provide systems and methods for the secure distribution of keys (e.g., encryption keys) in a network and/or a data communication channel. In many embodiments, a Kirchhoff-Law-Johnson-(like)-Noise (KLJN) secure key exchange protocol is utilized. Systems and methods of the subject invention can be utilized in any network where data is exchanged between elements (e.g., hosts) and where such elements are connected by at least one wire capable of transmitting electrical current. The term “wire” as used herein can include a cable or any other similar structure. Systems and methods of the subject invention can be utilized in a wide range of applications, including but not limited to power grids, telephone lines, ethernet cables, and television cables (e.g., coaxial cable). A KLJN secure key exchange protocol according to embodiments of the subject invention provides information security that is information theoretically secure.

An element exchanging data (e.g., a host) can be, for example, a building, a computer workstation, a laptop computer, a mobile electronic device, a modem, a router, or a telephone, though embodiments are not limited thereto. The hosts must be connected by at least one wire; that is, each host that is to exchange a key (e.g., an encryption key) must be have a wired connection to every other host with which such a key is to be exchanged. Advantageously, systems and methods of the subject invention can be implemented on existing networks, for example, an existing power grid, existing telephone lines, existing ethernet cables, and/or existing television cables. The term “existing network” as used herein refers to an existing infrastructure network, for example the power grid of an area (e.g., a city), a grid of telephone lines, television cabling for an area (e.g., a city), and/or ethernet cables in place for multiple locations.

Private key-based secure communications require a shared secret key between two stations that can communicate with each other over remote distances. In many secure communications, sharing such a key also utilizes electronic communications because courier and mail services are slow. However, software-based key distribution methods offer only limited security levels that are only computationally-conditional and not future-proof. That is, by using sufficient computing power, an eavesdropper can crack the key and all the communications that are using that key. Therefore, unconditional security requires more than a software solution. Unconditional security indicates that the security holds even for theoretically infinite computational power and can be referred to as “information theoretic security”. Embodiments of the subject invention offer such unconditional security by, among other techniques, utilizing the proper laws of physics.

One scheme that claims information theoretic security by utilizing the laws of physics is quantum key distribution (QKD). Though the security available in QKD schemes can be considered debatable, there is at least the potential to reach a satisfactory security level. However, QKD devices are prohibitively expensive and have other practical weaknesses, such as sensitivity to vibrations, bulk, range limitations, and the requirement for a special “dark optical fiber” cable with sophisticated infrastructure.

Embodiments of the subject invention offer the ability to exchange keys and information securely over wires. To utilize a wire connection for secure key exchange, different principles of physics are applied compared to those used in QKD that work with optical fibers. A KLJN key exchange system can be used and is a wire-based scheme that is free from several weaknesses of QKD. Similar to QKD, KLJN is an information theoretically secure key distribution; however it is robust, not sensitive to vibrations, has unlimited range, can be integrated on chips, and can use existing wire infrastructure (e.g., power lines, telephone lines, ethernet cables). In addition, KLJN-based networks can be constructed. Thus, in many embodiments, a secure key exchange system is a KLJN key exchange system.

In an embodiment of the subject invention, a KLJN secure key exchange protocol can be implemented over a power grid. This can be accomplished by, for example, utilizing filters for each host (e.g., building) and/or utilizing an extra wire in the power line. In many embodiments, the power grid can be a smart grid. A smart grid is an electrical power distribution network that uses information and communications technology to improve the security, reliability, efficiency, and sustainability of the production and distribution of electricity. A smart grid is a form of a cyber-physical system and enables greater efficiency through a higher degree of awareness and control while also introducing new failure modes associated with data being intercepted and compromised.

A power grid, such as a smart grid, offers an advantageous way to perform secure key exchange because each host (e.g., a building) in the grid is electrically connected. The KLJN channel is a wire, and the 50 Hz/60 Hz AC grid provides universal time synchronization. It is noted that not every building or device connected to the network need be a host; rather only those that are to exchange a key are hosts. Hosts on the network can each have a plurality of resistors (i.e., a first resistor, a second resistor, possibly a third resistor, etc.), and the resistance value of each corresponding resistor for each host can be identical (or identical within normal error tolerances e.g., 1%). That is, the resistance value for the first resistor of each host can be identical, the resistance value for the second resistor of each host can be identical, the resistance value for the third resistor (if present) of each host can be identical, etc. For example, each host can have a pair of resistors, R_{Low} and R_{High} (e.g., representing the 0 and 1 bit situations). At the beginning of each clock cycle, each host can randomly select and connect one of the resistors (whether there are two or more resistors). In practical applications, voltage noise generators enhance the Johnson noise of the resistors so that all resistors in the system have the same, publicly known effective noise-temperature, which can be referred to as T_{eff}. In an embodiment, T_{eff}≧10⁹ Kelvin. The enhanced Johnson noise voltages of the resistor result in a channel noise voltage between the wire and the ground, and a channel noise current in the wire. In an embodiment, low-pass filters can be used because the noise-bandwidth, which can be referred to as KLJN-band (its value can depend on the range), must be chosen so that wave, reflection, and propagation/delay effects are negligible, otherwise the security may be compromised.

Two hosts that are to exchange information can measure the mean-square amplitudes and/or within the KLJN-band in the line. From any of these values, the loop resistance can be calculated by using the Johnson noise formula with the noise-bandwidth. The hosts know their own resistor choice; thus, from the loop resistance, each host can deduce the resistance value and the actual bit status at the other end of the wire. In the ideal situation, the cases R_{L}|R_{H} and R_{H}|R_{L}, represent a secure bit exchange event because they cannot be distinguished by the measured mean-square values. An attacker or eavesdropper can do the very same measurements but will have no knowledge about any of the resistance choices; thus, the attacker is unable to extract the key bits from the measured loop resistance.

In certain embodiments, a protocol can have a reconfigurable filter system to create non-overlapping single loops in a network for the realization of the KLJN secure key distribution system. The protocol can be valid for one-dimensional radial networks (e.g., chain-like power line), which are typical of an electricity distribution network between a utility company and a customer, as well as for branched networks. Such a system can provide unconditionally secure key distribution over a network (e.g., a smart power grid) of arbitrary geometrical dimensions. In addition, many embodiments of the subject invention provide for overlapping key exchanges while utilizing more than two frequencies or frequency bands.

In an embodiment, a channel of a KLJN key exchange system can be a wire. Two remote stations can be connected by the wire and can have identical sets of resistors. For example, the two remote stations, which can be referred to as “A” and “B” or “Alice and “Bob” for simplicity, can have identical pairs of resistors. The pairs of resistors can be referred to as R_{L} and R_{H} and can represent the 0 and 1 bit situations. At the beginning of each clock cycle (e.g., in the case of a power grid, the 50 Hz or 60 Hz alternating current would provide universal time synchronization), Alice and Bob can randomly select and connect one of the resistors.

In many embodiments, one or more voltage noise generators can enhance the Johnson noise of the resistors (e.g., R_{L} and R_{H}) so that all resistors in the system have the same, publicly known effective noise-temperature, which can be referred to as T_{eff} In an embodiment, T_{eff}≧10⁹ Kelvin. The enhanced Johnson noise voltages {U_{L,A}(t) or U_{H,A}(t); and U_{L,B}(t) or U_{H,A}(t)} of the resistor can result in a channel noise voltage (U_{ch}(t)) between the wire (KLJN channel) and the ground, and a channel noise current I_{ch}(t) in the wire. The system can include a filter, for example a low-pass filter. Such a filter can be included because, for example, the noise-bandwidth, which can be referred to as KLJN-band Bₖₗⱼₙ, (its value can depends on the range), must be chosen so that wave, reflection, and propagation/delay effects are negligible; otherwise, security may be compromised. Filters can be used to protect against man-in-the-middle attacks. Alice and Bob can measure the mean-square amplitudes <U_{ch}² (t)> and/or <I_{ch}²(t)> within the KLJN-band in the line. From any of these values, the loop resistance can be calculated by using the Johnson noise formula with the noise-bandwidth T_{eff}:

$$〈 {U}_{ch}^{2} ( t ) 〉 = 4 {kT}_{eff} {R}_{loop} {B}_{kljn} \\ 〈 {I}_{ch}^{2} ( t ) 〉 = \frac{4 {kT}_{eff} {B}_{kljn}}{{R}_{loop}} \qquad ( 1 )$$

Alice and Bob each knows its own resistor choice; therefore, based on the loop resistance, the resistance value and the actual bit status at the other station of the wire can be deduced. In the ideal situation, the cases R_{L}|R_{H} and R_{H}|R_{L} represent a secure bit exchange event because they cannot be distinguished by the measured mean-square values. An eavesdropper, which can be referred to as Eve for simplicity, can do the very same measurements but will have no knowledge about any of the resistance choices; thus Eve is unable to extract the key bits from the measured loop resistance.

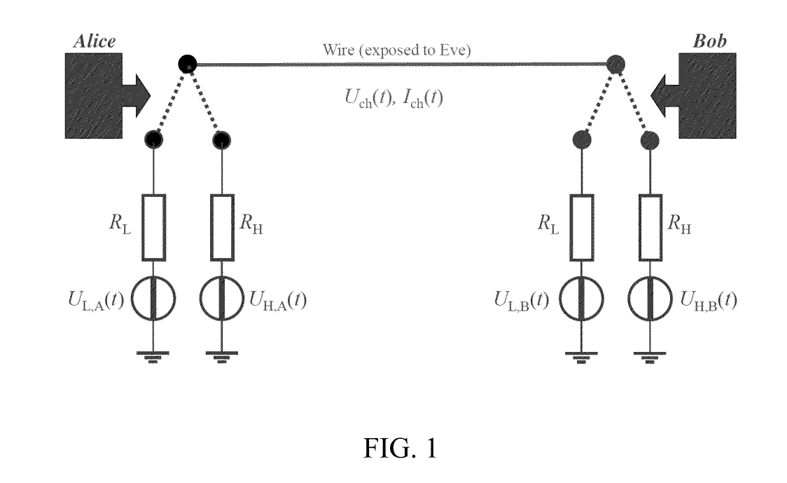

FIG. 1 shows a schematic of a KLJN key exchange system according to an embodiment of the subject invention. Referring to FIG. 1, each remote station (e.g., Alice and Bob) can have a pair of resistors (e.g., R_{L} and R_{H}) and at least one voltage generator (e.g., U_{L,A}(t) and/or U_{H,A}(t)). Alice's R_{L} can be identical to Bob's R_{L}, and Alice's R_{H} can be identical to Bob's R_{H}. Each of Alice and Bob can choose one of the resistors, and the enhanced Johnson noise voltages {U_{L,A}(t) or U_{H,A}(t); and U_{L,B}(t) or U_{H,A}(t)} of the resistor can result in a channel noise voltage (U_{ch}(t)) between the wire (KLJN channel) and the ground, and a channel noise current I_{ch}(t) in the wire. Alice and Bob can measure the mean-square amplitudes <U_{ch}² (t)> and/or <I_{ch}²(t)> within the KLJN-band in the line and, from any of these values, the loop resistance can be calculated by using equation 1 with the noise-bandwidth T_{eff}. Even though the wire is exposed to an eavesdropper (e.g., Eve), Eve has no knowledge about any of the resistance choices and will therefore be unable to extract the key bits from the measured loop resistance. It is possible that the system shown in FIG. 1 may be secure only against passive attacks in the idealized case (mathematical limit). In many embodiments, security enhancements (including but not limited to filters) can be included to provide protection against invasive attacks and against other types of vulnerabilities. In certain applications, electronic noise generators can emulate an enhanced Johnson noise with a publicly agreed high T_{eff}.

In a KLJN key exchange system of the subject invention, remote hosts must share a wired connection. This is not an issue for many applications because many hosts for such applications are already connected via a grid. For example, wires for a KLJN key exchange system can be for example, an electrical power grid (e.g., a smart grid), a telephone grid, a cable grid, a data line grid (e.g., ethernet cables), though embodiments are not limited thereto. Wires can be any conductive wires (i.e., capable of passing electrical current) known in the art.

In certain embodiments, a single loop connection is present between two remote hosts. Such a configuration, as shown in FIG. 1, is unconditionally secure. In some embodiments, if a grid is used to connect many remote hosts such that more than single loop connections are present, then filters can be used and controlled for the KLJN frequency band where the key exchange operates.

Secure key exchange can be achieved by switching on and off proper filtering units in a structured way within a KLJN system (e.g., a smart grid). Filters can pass or reject the KLJN frequency band Bₖₗⱼₙ, and/or the main frequency. The main frequency can be the regular frequency used over the wires. For example, in a power grid, the main frequency can be the power frequency (e.g., 50 or 60 Hz). When both Bₖₗⱼₙ and the main frequency (which can be referred to as fₚ for simplicity) are passed, it is a short; when both of frequencies are rejected, it is a break. The filters that pass or reject the KLJN frequency band and the main frequency can be referred to as “switched filters”. The pattern of connections between KLJN units can be varied to provide the exchange of a separate secure key for each possible pair of hosts by varying the network of filters and their connections accordingly.

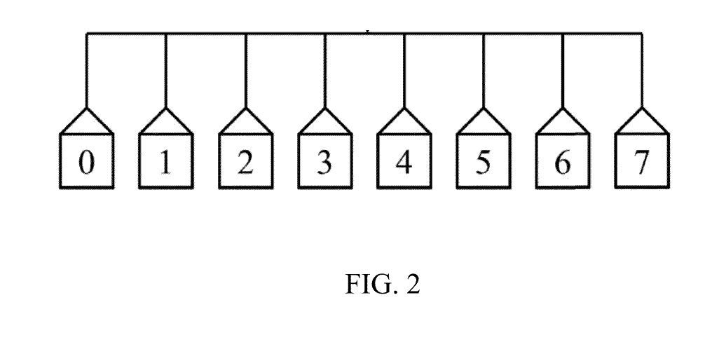

The functional units connected to the KLJN system (e.g., connected via a smart grid) can be referred to as hosts or remote hosts. A host is able to execute a KLJN key exchange in any direction simultaneously. For example, in a linear system as shown in FIG. 2, each host can execute a KLJN key exchange towards the left and right in a simultaneous way. Thus, each host in such a linear system has two independent KLJN units. The filter system must satisfy the following requirements: 1) hosts that currently do not execute KLJN key exchange should not interfere with those processes even if the KLJN signals pass through their connections; and 2) each host should be able to extract the main frequency (e.g., electrical power from the electric power system) without disturbing the KLJN key exchanges.

For demonstrative purposes only, key exchange between eight hosts in a one-dimensional system, as shown in FIG. 2, is described. The system used for demonstrative purposes is connected via electrical power lines. It is important to note that embodiments of the subject invention are not limited to one-dimensional systems, systems connected via electrical power lines, or systems having eight hosts; rather, these characteristics are present in this system solely for demonstrative purposes. In many embodiments of the subject invention, the network is branched.

Systems and methods of the subject invention can be used on a network having any reasonable number of hosts. The number of hosts of such a network can be, for example, any of the following values, at least any of the following values, no more than any of the following values, or any range having any of the following values as endpoints: 2, 3, 4, 5, 6, 7, 8, 9, 10, 20, 30, 40 50, 60, 70, 80, 90, 100, 1000, 10̂4, 10̂5, 10̂6, 10̂7, 10̂8, 10̂9, or 10̂10. Each host must have a wired connection to every other host with which there is to be an exchange of a key (e.g., an encryption key). The wired connection is by at least one wire, cable, or similar that is capable of conducting electrical current.

The size of a network can be defined as being of size N when that network has N+1 hosts. An example of a network of size N=7 is illustrated in FIG. 2. FIG. 2 shows a chain network or a one-dimensional grid having a network of size N=7. Intermediate hosts in the network can be in two different states according to the need: α) State 1 is defined when KLJN bandwidth Bₖₗⱼₙ is not allowed into the host; and β) State 2 is defined when KLJN bandwidth Bₖₗⱼₙ, is allowed into the host. The hosts at the two ends (labeled “0” and “7” for demonstrative purposes only) can be in similar situations except that they can communicate in only a single direction. The intermediate hosts can communicate in two directions, and the filters used for these intermediate hosts will be discussed in more detail.

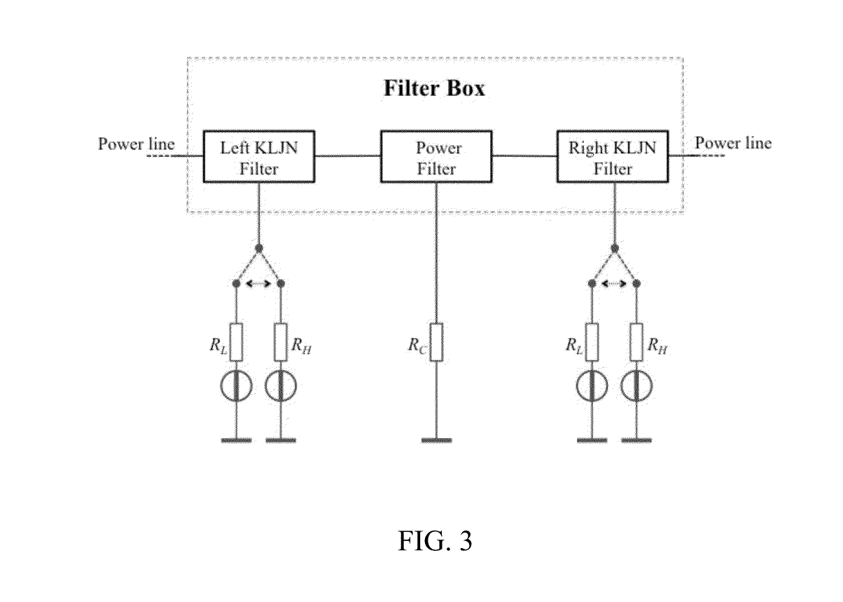

Each host of the network can include one or more filter boxes, which can distribute the KLJN signals and the main frequency (e.g., the power) and can be responsible for connecting the proper elements for the KLJN key exchange and supplying the hosts with the main signal or frequency (e.g., power frequency). FIG. 3 shows a schematic of building blocks in a filter box. The filters boxes can be controlled by, for example, a central server and/or an automatic algorithm, though embodiments are not limited thereto. Each filter box for an intermediate host can have three switched filters and a corresponding output wire. Referring to FIG. 3, each filter box can include: a first KLJN filter for KLJN key exchange in a first direction (e.g., a left KLJN filter for KLJN key exchange to the left); a second KLJN filter for KLJN key exchange in a second direction (e.g., a right KLJN filter for KLJN key exchange to the right); and a main signal filter to supply the main signal to the host (e.g., a power filter to supply power to the host). Each KLJN filter can be connected to a pair of resistors and at least one voltage source (as shown in FIG. 1, for each of Alice and Bob). The main signal filter can be connected to a resistor (labeled R_{C} in FIG. 3), which can have the same or a different resistance value from R_{L}, R_{H}, or both.

Properly-controlled filter boxes can provide non-overlapping KLJN loops between the hosts. KLJN loops can be non-overlapping loops, as the KLJN protocol is fundamentally peer-to-peer. If overlapping loops were allowed using only the KLJN frequency and the main frequency, then there is a possibility that an eavesdropper might be in between and would require the trust of the intermediate hosts. The reason for having two KLJN units per host is to decrease the time needed to connect every host by having simultaneous loops in both directions of the one-dimensional grid (e.g., toward left and right), without overlapping. It is possible to use overlapping key exchanges, but additional frequencies or frequency bands would be required to be used. That is, many embodiments of the subject invention provide for overlapping key exchanges while utilizing more than two frequencies or frequency bands.

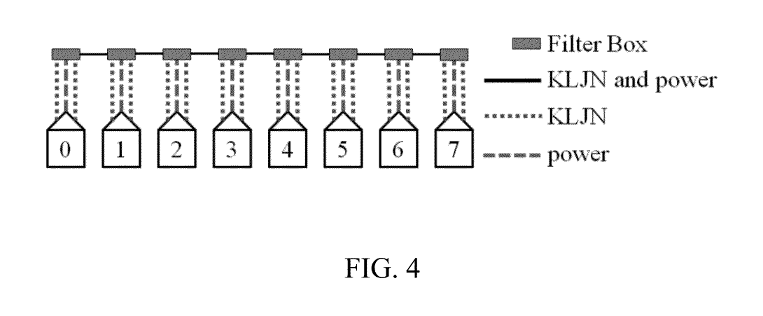

FIG. 4 shows an example one-dimensional network for N=7. Each host is connected to a filter box, and the filters boxes are connected to the grid (e.g., the power grid). Each host has three wire connections to its filter box. The solid black line means that both KLJN bandwidth and power frequency are passing through (e.g., ordinary wire). The (red) dotted lines carry Bₖₗⱼₙ, while rejecting fₚ. The (blue) dashed lines indicate that the power frequency is passing and the KLJN bandwidth is rejected.

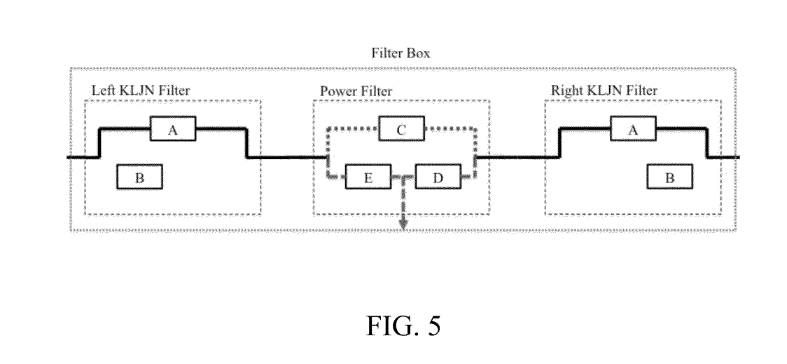

When there is a key exchange between the first host (host 0) and the last host (host 7) over the whole network (FIG. 4), then none of the hosts in between (host 1 through host 6) are allowed to access the KLJN band. In this state, the filter boxes of hosts 1 through 6 must separate their respective host from the KLJN band and at the same time supply them with power. This can be referred to as a working mode of the filter boxes of non-active hosts (State 1). The wiring and frequency transfer of the filter box in State 1 are shown in FIG. 5 and Tables 1 and 2. FIG. 5 shows a schematic of a filter box of an inactive host (i.e., when it is not executing KLJN key exchange) in State 1. Everything is passing from left and right, and the host can access only the power. Filter A is passing everything (shorted), filter B is disconnected. filter C is passing Bₖₗⱼₙ only, and filters E and D are passing fp only. State 1 is when the host is not allowed to access KLJN band. State 2 is when the host is allowed to access KLJN band. The filter box shown in FIG. 5 is in State 1.

TABLE 1
Truth table of the KLJN Filters in State 1 (inactive host).

| KLJN Filters | Filter A | Filter B |
|---|---|---|
| KLJN Bₖₗⱼₙ Allowed | Yes | No |
| Power Frequency Allowed | Yes | No |

TABLE 2
Truth table of the Power Filter in State 1 (inactive host).

| Power Filter | Filter C | Filter D | Filter E |
|---|---|---|---|
| KLJN Bₖₗⱼₙ Allowed | Yes | No | No |
| Power Frequency Allowed | No | Yes | Yes |

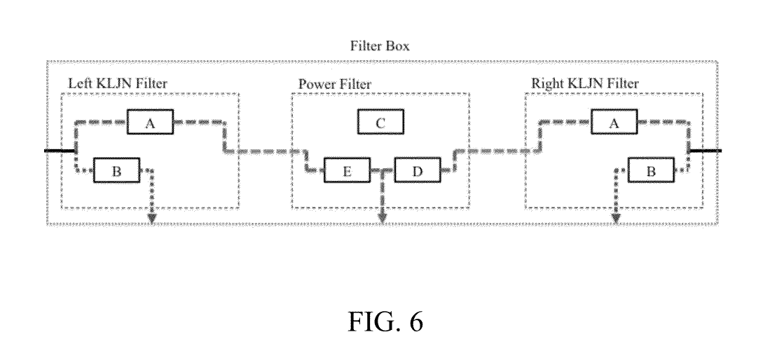

FIG. 6 shows a schematic of a filter box of an active host (i.e., when it is executing a KLJN key exchange) in State 2. The power is passing from left to right, but the KLJN band is not and the left and right KLJN units are separated while doing a key exchange to the left and the right. State 1 is when the host is not allowed to access KLJN band, and State 2 is when the host is allowed to access KLJN band. The filter box shown in FIG. 6 is in State 2.

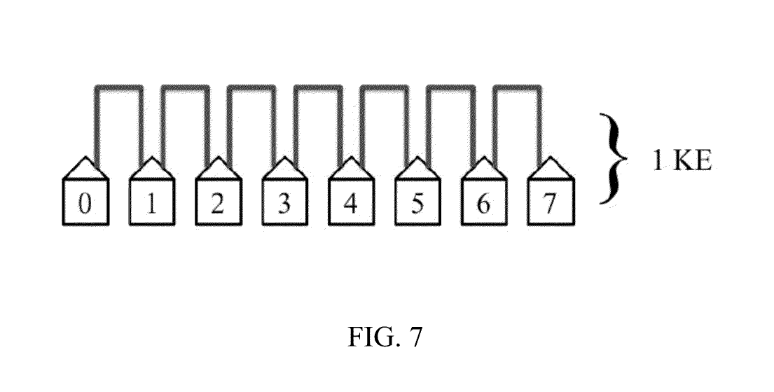

FIG. 7 shows a schematic of the hosts during key exchange. The nearest neighbors are connected, and this can be one step in a protocol for key exchange (e.g., this can be the first step). This step is the quickest and most efficient, as it has the most non-overlapping simultaneous loops and requires only 1 key exchange period (KE) to complete. Every host in this step has access to KLJN band and thus is in State 2.

Referring to FIGS. 6 and 7, seven key exchanges are occurring simultaneously with every host in the network active (allowed access to the KLJN band). The power filters of these hosts must separate the KLJN loops by rejecting Bₖₗⱼₙ. This can be referred to as working mode of the filter boxes of hosts executing key exchange (State 2). The wiring and frequency transfer of the filter box in State 2 are shown in FIG. 6 and Tables 3 and 4.

TABLE 3
Truth table of left KLJN filter when a host is in State 2 (active host).

| KLJN Filter | Filter A | Filter B |
|---|---|---|
| Bₖₗⱼₙ allowed | No | Yes |
| fₚ allowed | Yes | No |

TABLE 4
Truth table of power filter when a host is in State 2 (active host).

| Power Filter | Filter C | Filter D | Filter E |
|---|---|---|---|
| Bₖₗⱼₙ allowed | No | No | No |
| fₚ allowed | No | Yes | Yes |

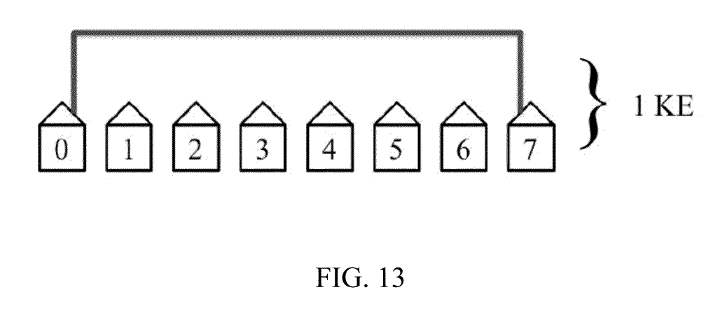

FIG. 13 shows a schematic of the hosts during key exchange. Only one key exchange is performed in this step. Hosts 1 through 6 are not allowed access to the KLJN band thus they are in State 1. This step is not the most efficient but only requires one KE since there is only one pair of hosts exchanging a key.

Referring to FIG. 13, there is one key exchange between the first host (host 0) and the last host (host 7) in the network, and all hosts in between (host 1 through host 6) are not allowed to access the KLJN band. In this state, the filter boxes of hosts 1 through 6 must separate their respective host from the KLJN band and at the same time supply them with power. This can be referred to as a working mode of the filter boxes of non-active hosts (State 1). The wiring and frequency transfer of the filter box in State 1 are shown in FIG. 5 and Tables 1 and 2.

To quickly and efficiently connect every host with all other hosts in the same one-dimensional network, a protocol can be established. The protocol must make every possible connection in the network, must not overlap loops (for this non-overlapping demonstrative example), and must be quick and efficient by making as many simultaneous loops as possible without overlapping. An example of such a protocol will be described in detail for demonstrative purposes, though embodiments of the subject invention are not limited to the protocol described (not even non-overlapping, one-dimensional embodiments).

In a classical KLJN system, where only the noise exists in the wire, the low-frequency cutoff of the noise is 0 Hz and the high-frequency cut-off is Bᵢₙ. In the case of KLJN in a smart grid, the power frequency is present. However, at short distances (e.g., less than 10 miles), the Bₖₗⱼₙ band can be beyond the power frequency fₚ and the difference is negligible. In such a situation, the shortest characteristic time in the system can be the correlation time τₖₗⱼₙ of the noise (τₖₗⱼₙ≈1/Bₖₗⱼₙ). Bₖₗⱼₙ can be determined by the distance L between two remote hosts (e.g., Alice and Bob) so that Bₖₗⱼₙ<<c/L, where c is the speed of light (for example, Bₖₗⱼₙ<<100 kHz for L=1 kilometer). Alice and Bob can perform a statistical analysis on the noise, which typically requires around 100 τₖₗⱼₙ duration (e.g., 0.01 seconds if Bₖₗⱼₙ=10 kHz) to have a sufficiently high fidelity (faster performance is expected in advanced KLJN methods). A bit exchange (BE) occurs when Alice and Bob have different resistor values, and this occurs in an average of 200 τₖₗⱼₙ (e.g., 0.02 seconds if Bₖₗⱼₙ=10 kHz). The length of the secure key exchange can be any arbitrary length. For example, if a key length is 100 bits, then 100 BE are required, which requires on average 20,000 τₖₗⱼₙ (e.g., approximately 2 seconds if Bₖₗⱼₙ is 10 kHz). Once the KLJN secure key has been exchanged the total amount of time needed to complete this is one KLJN secure key exchange period (KE). While the key exchange may be slow in certain instances, the system has the advantage that it is running continuously (not only during the handshake period like during common secure internet protocols); thus, a large number of secure key bits are produced during the continuous operation.

For the sake of simplicity only in this purely demonstrative example, the pessimistic estimation can be used by assuming a uniform duration for KE determined by the largest distance in the network, even though in reality short distances can exchange keys at a higher speed.

An example of a protocol for key exchange includes first connecting the nearest neighbor of every host. This allows the highest number of simultaneous non-overlapping loops per KE and only requires one KE to complete the first step. The protocol then connects the second nearest neighbors, thereby allowing the second-highest number of simultaneous loops per KE. However, due to the requirement of avoiding overlapping loops (for this non-overlapping one-dimensional demonstrative example), connecting each pairs of second nearest neighbors requires two KEs. The protocol then connects the third nearest neighbors, which requires 3 KEs to complete and connects the third most simultaneous loops per KE. The procedure can continue until the i-th nearest neighbor is equal to or less than half of the size of the network. If the number of steps i between the i-th nearest neighbors satisfies the relation i>N/2, then, to avoid overlapping loops, only one connection per KE is possible.

In an embodiment, a method of securely exchanging data (e.g., one or more keys such as encryption keys) over a network comprises utilizing a KLJN system and/or protocol as described herein.

Embodiments of the subject invention advantageously provide unconditionally secure key exchange over a network, such as a smart grid. A reconfigurable filter system can be used for the realization of a KLJN secure key distribution system. The system can achieve unconditionally secure key distribution over a network of arbitrary dimensions.

A possible attack strategy against the KLJN secure key exchange system could include utilizing the lack of exact thermal equilibrium in practical applications and could be based on cable resistance losses and the fact that the Second Law of Thermodynamics may not be able to provide full security when such losses are present. Such an attack does not challenge the unconditional security of the KLJN scheme, but it puts more stringent demands on the security/privacy enhancing protocol than other types of attack. In an embodiment of the subject invention, a simple defense protocol can be used to fully eliminate such an attack by increasing the noise-temperature at the side of the smaller resistance value over the noise-temperature at the side with the greater resistance value. Such a protocol can completely remove any potential information for an eavesdropper (i.e., an attacker), not only for an attack utilizing the lack of exact thermal equilibrium in practical applications, but also for a Bergou-Scheuer-Yariv attack, as discussed below. The most efficient potential attack strategies against the KLJN scheme can therefore be nullified.

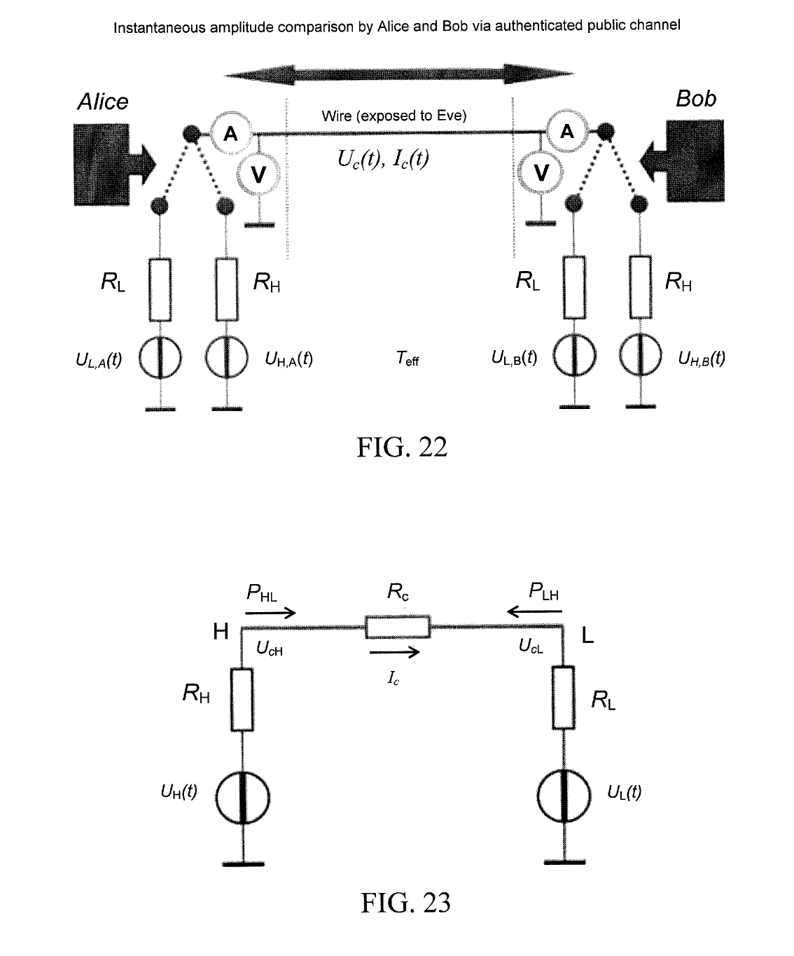

FIG. 22 shows a schematic view of a KLJN secure key exchange system according to many embodiments of the subject invention. In an embodiment, to defend against active and hacking attacks, the cable parameters and integrity can be randomly monitored; the instantaneous voltage U_{c}(t) and current I_{c}(t) amplitudes in the cable can be measured and compared via public authenticated data exchange; and full spectral and statistical analysis/checking can be carried out by the remote hosts (e.g., Alice and Bob). R, t, and T_{eff} denote resistance, time, and effective temperature, respectively. Line filters and other advanced hardware are not shown in FIG. 22, though they can be present.

Referring to FIG. 22, for the duration of a single bit exchange, the communicating parties (Alice and Bob) connect their randomly chosen resistor and corresponding noise-voltage generator to a KLJN channel (e.g., a wire, line, or cable). The resistors can be randomly selected from the publicly known set {R_{L},R_{H}}, R_{L}≠R_{H}, where the elements represent low (L) and high (H) bit values. The Gaussian voltage noise generators—mimicking the Fluctuation-Dissipation Theorem and delivering band-limited white noise with publicly agreed bandwidth—produce enhanced thermal (Johnson) noise at a publicly agreed effective temperature T_{eff}, which can be, for example, T_{eff}≧10⁹ K. Thus, the temperature of the wire can be neglected. The noises are statistically independent of each other and from the noise of the former bit period.

In the case of secure bit exchange (i.e., the LH or HL bit situations for Alice and Bob), an eavesdropper (Eve) cannot distinguish between these two situations by measuring the mean-square value of the voltage U_{c}(t) and/or current I_{c}(t) in the cable, because both arrangements lead to the same result. For demonstrative purposes only, the case where one of these secure bit exchange situations (either LH or HL) applies will be considered. Though, embodiments of the subject invention are not limited to cases where one of these secure bit exchange situations (either LH or HL) applies.

To avoid potential information leak by variations in the shape of a probability distribution, the noises are Gaussian, as other distributions may not be secure. Security is provided at least in part by the Second Law of Thermodynamics because directional information, due to the direction of power flow, does not exist because the mean power flow is zero even though the LH and HL situations have asymmetric resistance arrangements. That is, the security of the ideal KLJN scheme against passive (non-invasive listening/measuring) attacks is as strong as the impossibility to build a perpetual motion machine of the second kind. The security against active (invasive) attacks is provided at least in part by the robustness of classical physical quantities, which guarantees that these quantities can be monitored (and their integrity with the cable parameters and model can be checked) continuously without destroying their values. It can be observed, in passing, that the situation is totally different for the case of quantum physics.

The Bergou-Scheuer-Yariv (BSY) cable resistance attack is an attack against a non-ideal KLJN scheme. The BSY cable resistance attack utilizes the fact that, due to the non-zero cable resistance, the mean-square voltage will be slightly less at the cable end with the smaller resistance value than at the other end with the greater resistance.

FIG. 23 shows a schematic view of a scheme devised to illustrate the BSY attack and the Second-Law-attack. Alice's and Bob's locations are arbitrary in the figure. During the Second-Law-attack, the powers flowing out from the “H” and “L” ends of the cable are calculated and compared. The temperature of the cable resistor Rc can be neglected because of the high noise temperature of the generators. The notation is consistent with that in FIG. 22. Eve's measured absolute difference between the mean-square voltages <U_{cH}²(t)> and <U_{cL}²(t)> of the “H” and “L” ends (see FIG. 23) is given by:

$${Δ}_{KS} = \vert 〈 {U}_{cH}^{2} ( t ) 〉 - 〈 {U}_{cL}^{2} ( t ) 〉 \vert = 4 {kT}_{eff} Δ f \vert \frac{{R}_{c}^{2} ( {R}_{H} - {R}_{L} )}{{( {R}_{H} + {R}_{c} + {R}_{L} )}^{2}} \vert , \qquad ( 18 )$$

where k is Boltzmann's constant, Δf is noise bandwidth and R_{c} is cable resistance. Clearly Δ_{KS} scales with the square of the cable resistance, i.e., Δ_{KS} ∝R_{c}² The rules about transformations of noise spectra in linear systems, along with Johnson's formula for thermal noise can be used to derive Equation (19).

[symbol]

U_{R}²(t) [symbol] =4kT_{eff}RΔf (19)

Here, <U_{R}²(t)> denotes mean-square voltage fluctuations on the resistor, with resistance R, within the bandwidth Δf. The cable resistance has a non-zero value, and therefore the resistors and their noise generators are not in thermal equilibrium in practical versions of the KLJN system (with T_{eff} much greater than the cable temperature). Consequently, the Second Law of Thermodynamics may not be able to provide full security. The cable-heating powers by the generators at the “H” and “L” ends are different and are given by

$$\begin{matrix}{P}_{Hc} = 〈 {I}_{A}^{2} ( t ) 〉 {R}_{c} = \frac{4 {kT}_{eff} {R}_{H} Δ f}{{( {R}_{H} + {R}_{c} + {R}_{L} )}^{2}} {R}_{c} , \\ and & ( 20 ) \\ {P}_{Lc} = 〈 {I}_{B}^{2} ( t ) 〉 {R}_{w} = \frac{4 {kT}_{eff} {R}_{L} Δ f}{{( {R}_{H} + {R}_{c} + {R}_{L} )}^{2}} {R}_{c} = {P}_{Hc} \frac{{R}_{L}}{{R}_{H}} . & ( 21 )\end{matrix}$$

The difference between P_{Hc} and P_{Lc} can be utilized for the Second-Law-attack in the case where the resistor values R_{H} and R_{L} are publicly known. The implementation of this attack can be used to measure and compare the net power flows at the two ends of the cable, as shown in FIG. 23. The mean power flow P_{HL} from the “H” end toward the “L” end of the cable, and the mean power flow P_{LH} from the “L” end toward the “H” end are, respectively,

$$\begin{matrix}{P}_{HL} = 〈 {U}_{H}^{2} ( t ) 〉 {( \frac{{R}_{c} + {R}_{L}}{{R}_{H} + {R}_{c} + {R}_{L}} )}^{2} \frac{1}{{R}_{c} + {R}_{L}} - 〈 {U}_{L}^{2} ( t ) 〉 {( \frac{{R}_{H}}{{R}_{H} + {R}_{c} + {R}_{L}} )}^{2} \frac{1}{{R}_{H}} = 4 {kT}_{eff} Δ f \frac{{R}_{H} ( {R}_{c} + {R}_{L} ) - {R}_{L} {R}_{H}}{{( {R}_{H} + {R}_{c} + {R}_{L} )}^{2}} = 4 {kT}_{eff} Δ f \frac{{R}_{H} {R}_{c}}{{( {R}_{H} + {R}_{c} + {R}_{L} )}^{2}} & ( 22 ) \\ and & \\ {P}_{LH} = 〈 {U}_{L}^{2} ( t ) 〉 {( \frac{{R}_{c} + {R}_{H}}{{R}_{H} + {R}_{c} + {R}_{L}} )}^{2} \frac{1}{{R}_{c} + {R}_{H}} - 〈 {U}_{H}^{2} ( t ) 〉 {( \frac{{R}_{L}}{{R}_{H} + {R}_{c} + {R}_{L}} )}^{2} \frac{1}{{R}_{L}} = 4 {kT}_{eff} Δ f \frac{{R}_{L} ( {R}_{c} + {R}_{H} ) - {R}_{H} {R}_{L}}{{( {R}_{H} + {R}_{c} + {R}_{L} )}^{2}} = 4 {kT}_{eff} Δ f \frac{{R}_{L} {R}_{c}}{{( {R}_{H} + {R}_{c} + {R}_{L} )}^{2}} & ( 23 )\end{matrix}$$

The power flows P_{HL} and P_{LH} are directly measurable by Eve, and their difference,

$$Δ {P}_{HL} = {P}_{HL} - {P}_{LH} = 4 {kT}_{eff} Δ f \frac{{R}_{c} ( {R}_{H} + {R}_{L} )}{{( {R}_{H} + {R}_{c} + {R}_{L} )}^{2}} \qquad ( 24 )$$

gives the difference between the powers supplied by the two cable ends; with the measured cable voltages and current (see FIG. 23) it is

$$Δ {P}_{HL} = {P}_{HL} - {P}_{LH} = 〈 {I}_{c} ( t ) {U}_{cH} ( t ) 〉 - 〈 {I}_{c} ( t ) {U}_{cL} ( t ) 〉 = 〈 [ {U}_{cH} ( t ) + {U}_{cL} ( t ) ] {I}_{c} ( t ) 〉 . \qquad ( 25 )$$

The opposite current sign at the “L” end expresses the fact that the current flowing out from the “H” end is flowing into the “L” end (using the same current sign would instead provide the power dissipated in the cable resistance, which is always positive and gives no directional information).

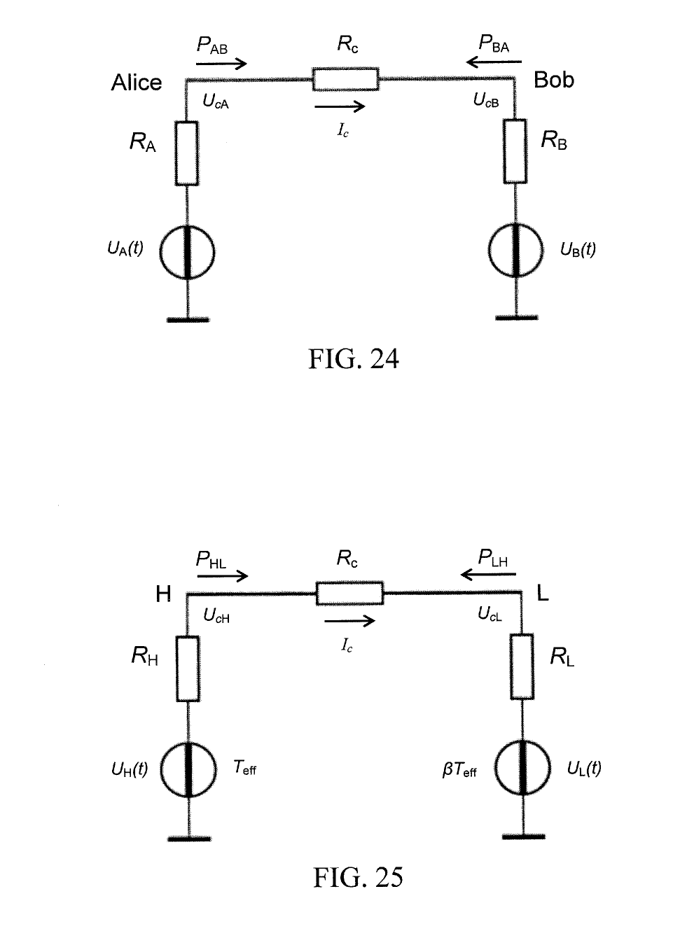

FIG. 24 shows a schematic view of Eve's measurements during a Second-Law-attack. The powers flowing out from the two ends of the cable are measured and compared. The notation is consistent with that in FIG. 22.

If it were supposed that Eve measures the above current-voltage cross-correlations at the two ends and evaluates the pertinent quantities, with the notation introduced in FIG. 24, the following can be derived.

ΔP_{AB}=P_{AB}−P_{BA}= [symbol] [U_{cA}(t)+U_{cB}(t)]I_{c}(t) [symbol] (26)

As an example, suppose that R_{H} has the greater resistance value and R_{L} the smaller one, i.e., R_{L}<R_{H}. In the ideal case, when R_{c}=0, ΔP_{AB}=0 in accordance with the Second Law of Thermodynamics, which yields <U_{C}(t)I_{C}(t)>=0. However, in the practical case, with R_{c}>0:

(i) if ΔP_{AB}>0, then Alice has R_{H} and Bob has R_{L},
(ii) if ΔP_{AB}<0, then Alice has R_{L} and Bob has R_{H}.

The signal inherent in the Second-Law-attack scales linearly with R_{c}, which provides a much better situation for Eve—especially in the case of vanishing cable resistance—than the square-law scaling of the BSY attack. Moreover, in a practical case where R_{c}<<R_{L}<<R_{H}, Eve's signal-to-noise ratio is always greater in the Second-Law-attack than in the BSY attack. This is due to the fact that the BSY attack evaluates the dc fraction of ≈R_{c}²/(R_{L}R_{H}) in the measured (empirical) mean-square channel noise voltage, while the Second-Law-attack evaluates the dc fraction of R_{c}/R_{H} in the measured mean power flow. The measured mean-square channel noise voltage and the measured mean power flow follow similar statistics because they are the time average of the products of Gaussian processes.

The Second-Law-attack is an elegant and efficient one, but it does not challenge the unconditional security of the KLJN scheme. Eve's probability p of successful guessing can arbitrarily approach the limit p=0.5 by proper tuning of the parameters inherent in the KLJN scheme, such as resistances and bandwidth, and privacy amplification can be implemented if needed. Though, a Second-Law-attack may significantly increase the demands on parameter tuning and/or necessitate elaborate privacy amplification, which may come at a cost.

In an embodiment, a natural/simple defense can be used against a Second-Law-attack. If the cable and the resistors are kept at the same temperature, such a temperature-equilibration method virtually eliminates any Second-Law-attack information for Eve (but not necessarily the information in the BSY-attack, albeit its formula for the information leak is changed). Temperature equilibration constitutes a very simple defense, but the cable temperature and its possible variations cannot be neglected any longer. If the cable temperature is different from that of the resistors, then the KLJN scheme is vulnerable to a Hao-type attack. In principle, with cables of homogeneous temperatures, this attack can be avoided if Alice and Bob are able to monitor the temperature value of the cable by resistance and Johnson noise measurements, since they can then choose T_{eff} to be the same as the cable temperature. While these steps can be taken, the KLJN scheme is not necessarily still considered simple. Moreover, the mentioned defense method may be unpractical in certain applications because of the requirement of a homogeneous cable temperature, small noise levels, and because it inhibits the adoption of enhanced KLJN methods wherein Alice and Bob eliminate their own contributions in order to accomplish higher speed and security.

In an embodiment, an advanced defense can be used against a Second-Law-attack. The cable end with the smaller resistance value can emit less power toward the other end, and this can be the foundation of a Second-Law-attack. This effect, as well as Eve's related signal, can be partially or completely eliminated by properly changing the ratio of the noise-temperatures of the generators for the resistors with the smaller and the greater resistance values (see FIG. 25).

FIG. 25 shows a schematic view of the elimination of the Second-Law-attack and the BSY-attack by introduction of a proper temperature offset. The notation is consistent with that in FIG. 22.

If an offset in the noise-temperatures of the generators for the R_{H} and the R_{L} resistors were introduced, then Equation (27) holds, where T_{eff} is the noise temperature at the R_{H} resistors and βT_{eff} is the noise temperature of the R_{L} resistors.

ΔP_{HL}=P_{HL}(T_{eff})−P_{LH}(βT_{eff})=0 (27)

The solution of the equation is

$$β = \frac{1 + \frac{{R}_{c}}{{R}_{L}}}{1 + \frac{{R}_{c}}{{R}_{H}}} . \qquad ( 28 )$$

This value of β for the temperature-offset consequently eliminates Eve's opportunity to use the Second-Law-attack. It can be determined that β>1 for R_{L}<R_{H} and β<1 for R_{H}<R_{L}.

Reevaluating the analysis of the BSY with the temperature offset given by Equation (28), Equation (29) can be obtained.

$$\begin{matrix}{Δ}_{KS} ( {T}_{eff} , β {T}_{eff} ) = \vert 〈 {U}_{cH}^{2} ( t ) 〉 - 〈 {U}_{cL}^{2} ( t ) 〉 \vert \\ = 4 {kT}_{eff} Δ {fR}_{H} \vert \frac{{R}_{c}^{2} ( 1 - α β ) - α {R}_{H} {R}_{c} ( β - 1 )}{{( {R}_{H} + {R}_{c} + {R}_{L} )}^{2}} \vert ,\end{matrix} \qquad ( 29 )$$

where α=(R_{L}/R_{H}). By substituting the above value for β, the nominator becomes zero so that

Δ_{KS}(T_{eff},βT_{eff})=| [symbol] U_{cH}²(t,T_{eff}) [symbol] − [symbol] U_{cL}²(t,βT_{eff}) [symbol] |=0 (30)

Hence, a modification of the noise temperature of the generators supplying the noise of the RL resistors by the factor β yields a complete elimination of the strongest attacks against the KLJN key exchange scheme, namely the Second-Law-attack and the BSY-attack.

According to certain embodiments of the subject invention, an advanced defense against a Second-Law-attack involves a proper increase of the noise-temperature of the noise generator for the smaller resistances compared to that of the generators for the greater resistances, which surprisingly eliminates not only the Second-Law-attack but also a BSY attack. Removing these attacks can radically reduce Eve's fidelity while increasing that of Alice and Bob as a result of the potentially allowed longer bit-exchange periods and/or higher bandwidths. In order to reduce the risk for hacking attacks or attacks due to possible malfunction, not only should the voltage and current amplitudes be monitored and compared at the two cable ends but Gaussianity, spectral, and other proper statistical checks can also be run on the signals, and the cable transfer function and signal integrity can be monitored against hacking.

### EXEMPLIFIED EMBODIMENTS

The invention includes, but is not limited to, the following embodiments:

### Embodiment 1

A Kirchhoff-Law-Johnson-(like)-Noise (KLJN) system for secure key distribution, comprising:

a wired network; and

a plurality of hosts connected to each other on the wired network,

wherein each host is connected to every other host by a continuous wired path capable of transmitting electrical current,

wherein each host of the plurality of hosts comprises a first resistor and is configured to produce a first-resistor enhanced Johnson noise voltage when the first resistor is connected to a voltage source,

wherein each host of the plurality of hosts further comprises a second resistor and is further configured to produce a second-resistor enhanced Johnson noise voltage when the second resistor is connected to a voltage source,

wherein the resistance value of the first resistor of each host is identical to that of all other hosts of the plurality of hosts, and

wherein the resistance value of the second resistor of each host is the identical to that of all other hosts of the plurality of hosts.

### Embodiment 2

The system according to embodiment 1, wherein each host further comprises a filter box.

### Embodiment 3

The system according to embodiment 2, wherein the filter box comprises:

a first KLJN filter for KLJN key exchange; and

a main signal filter for supplying a main signal of the network to the host having the filter box.

### Embodiment 4

The system according to embodiment 3, wherein at least one of the first KLJN filter and the main signal filter is a low pass filter.

### Embodiment 5

The system according to any of embodiments 3-4, wherein the first KLJN filter is connected to the first and second resistors, such that the first KLJN filter is connected between all other hosts and the first and second resistors of the host having the filter box.

### Embodiment 6

The system according to any of embodiments 3-5, wherein each host comprises a third resistor, and wherein the main signal filter is connected to the third resistor of the host having the filter box such that the main signal filter is connected between all other hosts and the third resistor of the host having the filter box.

### Embodiment 7

The system according to any of embodiments 3-6, wherein the KLJN filter comprises a first sub-filter and a second sub-filter,

wherein, when open, the first sub-filter permits a signal to pass through the KLJN filter without reaching the first and second resistors,

wherein, when open, the second sub-filter permits a signal to reach the first and second resistors,

wherein the KLJN filter is configured such that, in an inactive state, the first sub-filter is open to Johnson noise and the second sub-filter is closed to Johnson noise, and

wherein the KLJN filter is configured such that, in an active state, the first sub-filter is closed to Johnson noise and the second sub-filter is open to Johnson noise.

### Embodiment 8

The system according to any of embodiments 1-7, wherein the wired network is an existing infrastructure network.

### Embodiment 9

The system according to any of embodiments 1-8, wherein the wired network is a smart power grid.

### Embodiment 10

The system according to any of embodiments 3-8, wherein the wired network is a smart power grid, and wherein the main signal filter is a power filter for supplying power to the host having the filter box.

### Embodiment 11

The system according to any of embodiments 3-10, wherein the plurality of hosts comprises at least three hosts.

### Embodiment 12

A Kirchhoff-Law-Johnson-(like)-Noise (KLJN) method for secure key distribution using a system, wherein the system comprises:

a wired network; and

a plurality of hosts connected to each other on the wired network,

wherein each host is connected to every other host by a continuous wired path capable of transmitting electrical current,

wherein each host of the plurality of hosts comprises a first resistor and a second resistor, wherein the resistance value of the first resistor of each host is identical to that of all other hosts of the plurality of hosts,

wherein the resistance value of the second resistor of each host is the identical to that of all other hosts of the plurality of hosts, and

wherein the method comprises:
connecting, to a voltage source, exactly one of the first resistor or the second resistor of a first host of the plurality of hosts, thereby producing a first-host enhanced Johnson noise voltage, which is transmitted to a second host of the plurality of hosts; and
connecting, to a voltage source, exactly one of the first resistor or the second resistor of the second host, thereby producing a second-host enhanced Johnson noise voltage, which is transmitted to the first host.

### Embodiment 13

The method according to embodiment 12, wherein each host further comprises a filter box.

### Embodiment 14

The method according to embodiment 13, wherein the filter box comprises:

a first KLJN filter for KLJN key exchange; and

a main signal filter for supplying a main signal of the network to the host having the filter box.

### Embodiment 15

The method according to embodiment 14, wherein at least one of the first KLJN filter and the main signal filter is a low pass filter.

### Embodiment 16

The method according to any of embodiments 14-15, wherein the first KLJN filter is connected to the first and second resistors, such that the first KLJN filter is connected between all other hosts and the first and second resistors of the host having the filter box.

### Embodiment 17

The method according to any of embodiments 14-16, wherein each host comprises a third resistor, and wherein the main signal filter is connected to the third resistor of the host having the filter box such that the main signal filter is connected between all other hosts and the third resistor of the host having the filter box.

### Embodiment 18

The method according to any of embodiments 14-17, wherein the KLJN filter comprises a first sub-filter and a second sub-filter,

wherein, when open, the first sub-filter permits a signal to pass through the KLJN filter without reaching the first and second resistors,

wherein, when open, the second sub-filter permits a signal to reach the first and second resistors,

and wherein the method further comprises:
placing the KLJN filter in an inactive state by opening the first sub-filter to Johnson noise and closing the second sub-filter to Johnson noise; and
placing the wherein the KLJN filter is in an active state, when the host having the KLJN filter is receiving a key, by closing the first sub-filter to Johnson noise and opening the second sub-filter to Johnson noise.

### Embodiment 19

The method according to any of embodiments 12-18, wherein the wired network is an existing infrastructure network.

### Embodiment 20

The method according to any of embodiments 12-19, wherein the wired network is a smart power grid.

### Embodiment 21

The method according to any of embodiments 14-19, wherein the wired network is a smart power grid, and wherein the main signal filter is a power filter for supplying power to the host having the filter box.

### Embodiment 22

The method according to any of embodiments 12-21, wherein the plurality of hosts comprises at least three hosts.

### Embodiment 23

The method according to any of embodiments 12-22, wherein the method further comprises connecting, to a voltage source, exactly one of the first resistor or the second resistor of a third host of the plurality of hosts, thereby producing a third-host enhanced Johnson noise voltage (“third-host” is used as a label only), which is transmitted to the first host.

A greater understanding of the present invention and of its many advantages may be had from the following examples, given by way of illustration. The following examples are illustrative of some of the methods, applications, embodiments and variants of the present invention. They are, of course, not to be considered as limiting the invention. Numerous changes and modifications can be made with respect to the invention.

### Example 1

The one-dimensional grid shown in FIG. 2 was analyzed for KLJN key exchange, and it was determined that, for N=7, 16 key exchange periods (KEs) (e.g., approximately 32 seconds if Bₖₗⱼₙ is 10 kHz when the keys are 100 bits long) are required. Using this protocol, the analytic form of the exact time required to fully arm every host with enough keys to securely communicate with every host in the network is dependent on the size of the network and whether the network has an even or odd size. The analysis in this example focuses on the case where N is an odd number.

A network of size N=7, as shown in FIG. 2, was analyzed. The network has eight hosts with index i, where 0≦i≦7. The network has seven intermediate connections between the first host and the last host.

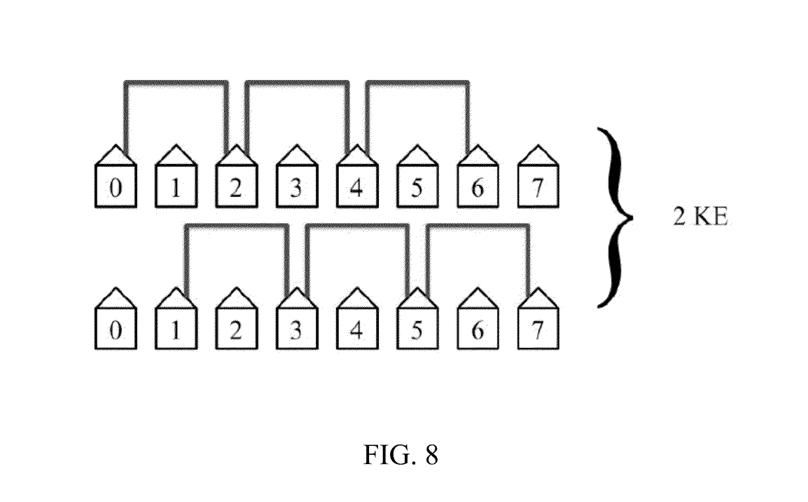

The first step in the protocol connects the nearest neighbors, as shown in FIG. 7. FIG. 8 shows a schematic of the second step in the protocol, which connects the second-nearest neighbors. This step is the second quickest and the second most efficient. It has the second most non-overlapping simultaneous loops and requires 2 KEs to complete.

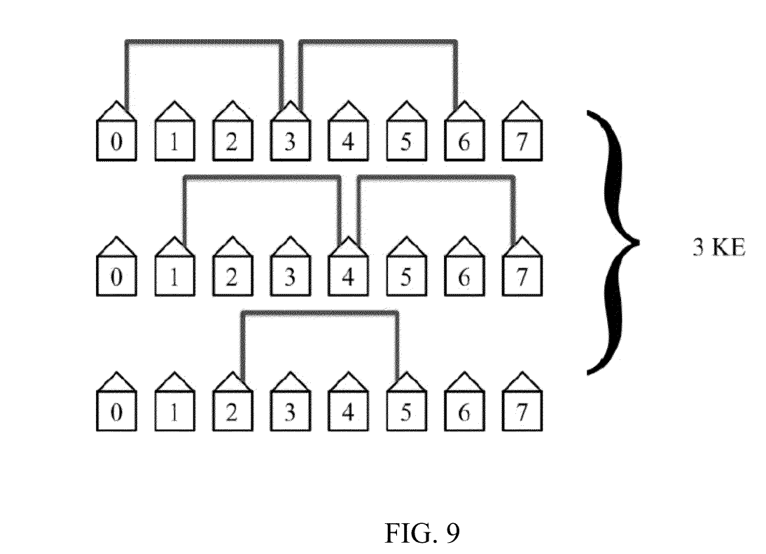

FIG. 9 shows a schematic of the third step in the protocol, which connects the third-nearest neighbors. This step is not as efficient as the first two steps but still has simultaneous loops in two of its KE steps. This step requires 3 KEs to complete.

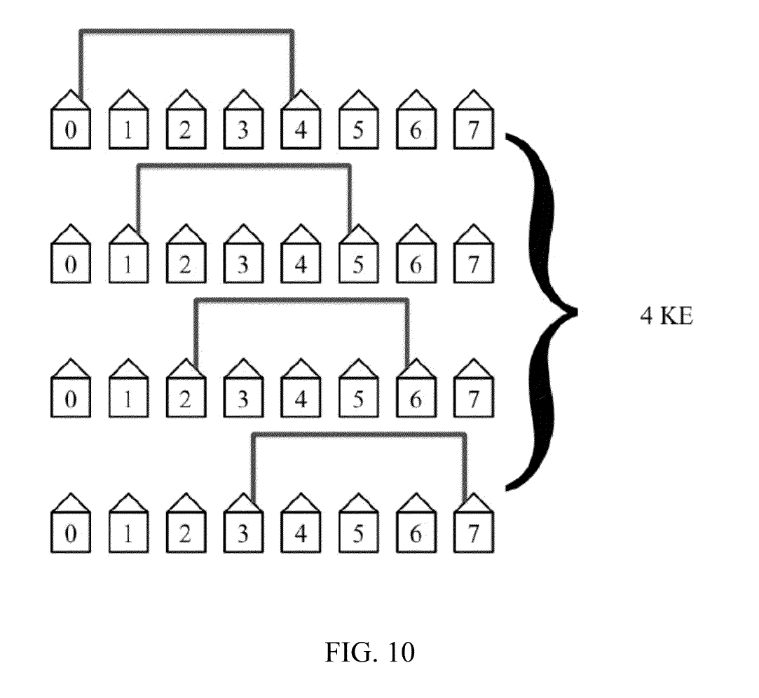

FIG. 10 shows a schematic of the fourth step in the protocol, which connects the fourth-nearest neighbors. This step is the slowest and least efficient step in the protocol when N=7. This step requires 4 KEs to complete. The midpoint is considered when the distance between key-exchanging hosts is equal to half the length of the network. Simultaneous loops with disconnected hosts are not possible beyond the midpoint. The slowest and least efficient steps occur at the midpoint of the protocol.

FIG. 11 shows a schematic of the fifth step in the protocol, which connects the fifth-nearest neighbors. This step is not efficient since simultaneous non-overlapping loops with disconnected hosts cannot occur. This step takes 3 KEs to complete. It is also inefficient since it is beyond the midpoint thus only a single loop is possible, but it requires fewer KEs since there are only three such pairs.

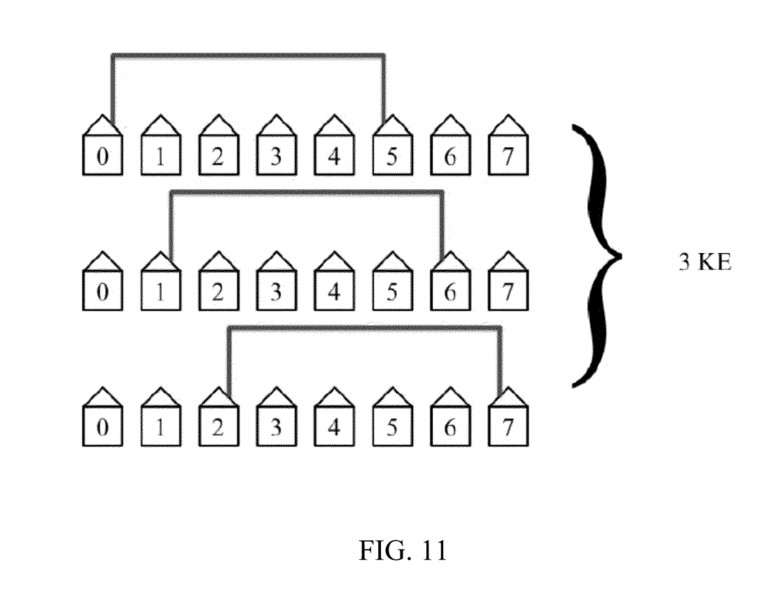

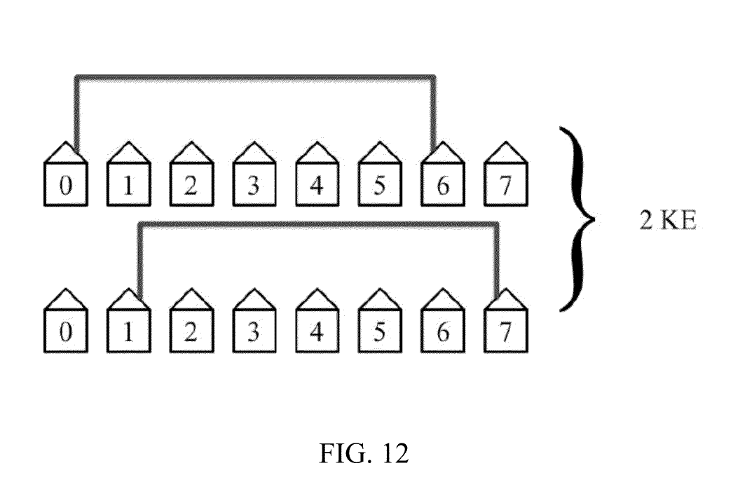

FIG. 12 shows a schematic of the sixth step in the protocol, which connects the sixth-nearest neighbors. This step requires only 2 KEs since there are only two possibilities.

The protocol then connects the seventh-closest neighbors, as shown in FIG. 13. This requires 1 KE since there is only one such pair of hosts.

This completes the protocol for an example of size N=7, and a pattern emerges for N being odd. The pattern is 1 KE, 2 KE, 3 KE, 4 KE, 3 KE, 2 KE, and 1 KE. This is essentially Gauss's counting technique up to N/2 and back. The total number of KEs needed is 1KE+2KE+3KE+4KE+3KE+2KE+1KE=16KE. The speed or time requirement of the protocol for a network of arbitrary size N with N being odd is ((N+1)/2)² KEs and can be derived as follows.

Since N is odd, it can be expressed as;

N=2n+1. (2)

To find the midpoint, n can be solved for and expressed in terms of N to give the following;

$$\frac{N - 1}{2} = n . \qquad ( 3 )$$

The pattern when N is odd has the following form;

$$1 + 2 + … + ( n - 1 ) + n + ( n - 1 ) + … + 2 + 1 = {( \frac{N - 1}{2} )}^{2} . \qquad ( 4 )$$

Expressing n in terms of N gives;

$$1 + 2 + … + ( \frac{N - 1}{2} - 1 ) + ( \frac{N - 1}{2} ) + ( \frac{N - 1}{2} - 1 ) + … + 2 + 1 = {( \frac{N - 1}{2} )}^{2} . \qquad ( 5 )$$

It is known from Gauss's counting method that,

$$1 + 2 + … + N = \frac{N ( N + 1 )}{2} . \qquad ( 6 )$$

In the pattern, Gauss's counting method can be used twice to find the sum as follows.

$$\underbrace{1 + 2 + … + ( \frac{N - 1}{2} - 1 )}_{\frac{( \frac{N - 1}{2} - 1 ) ( \frac{N - 1}{2} )}{2}} + ( \frac{N - 1}{2} ) + \underbrace{( \frac{N - 1}{2} - 1 ) + … + 2 + 1}_{\frac{( \frac{N - 1}{2} - 1 ) ( \frac{N - 1}{2} )}{2}} = {( \frac{N - 1}{2} )}^{2} . \qquad ( 7 )$$

This simplifies to

$$( \frac{( \frac{N - 1}{2} ) ( \frac{N - 1}{2} - 1 )}{2} ) + ( \frac{N - 1}{2} ) + ( \frac{( \frac{N - 1}{2} ) ( \frac{N - 1}{2} - 1 )}{2} ) = {( \frac{N - 1}{2} )}^{2} . \qquad ( 8 )$$

Thus, the speed of the network is proportional to (N²)/4 with N being odd and the size of the network.

### Example 2

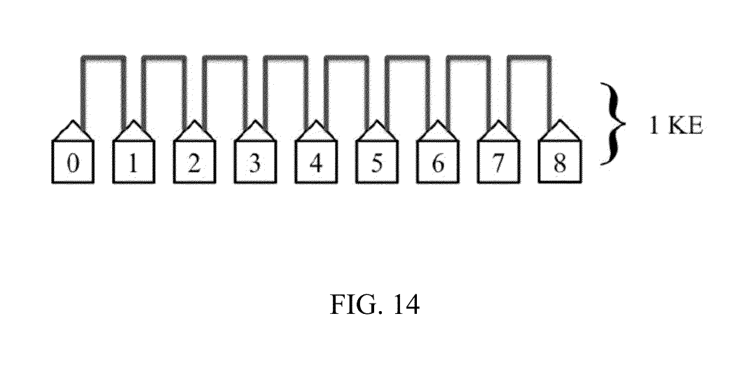

The one-dimensional grid shown in FIG. 14 was analyzed for KLJN key exchange, and it was determined that, for N=8, 20 key exchange periods (KEs) (e.g., approximately 40 seconds if Bₖₗⱼₙ, is 10 kHz when the keys are 100 bits long) are required. Using this protocol, the analytic form of the exact time required to fully arm every host with enough keys to securely communicate with every host in the network is dependent on the size of the network and whether the network has an even or odd size. The analysis in this example focuses on the case where N is an even number.

A network of size N=8, as shown in FIG. 14, was analyzed. The network has nine hosts with index i, where 0≦i≦8. The network has eight intermediate connections between the first host and the last host.

FIG. 14 shows a schematic of the first step in the protocol, which connects the nearest neighbors. This step is the quickest and most efficient. It has the most non-overlapping simultaneous loops and requires only 1 KE to complete.

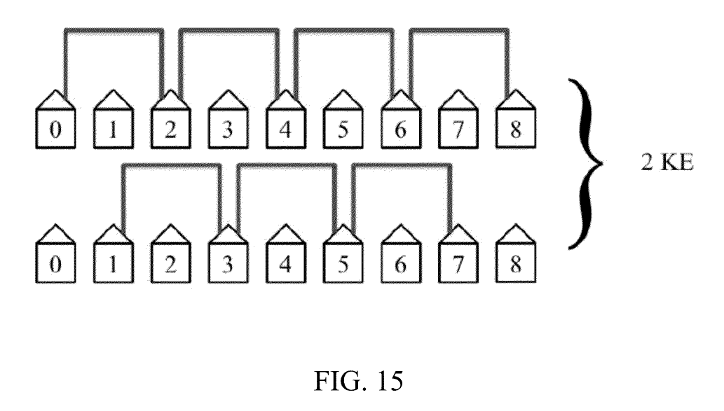

FIG. 15 shows a schematic of the second step in the protocol, which connects the second-nearest neighbors. This step requires 2 KEs to complete and has the second most simultaneous non-overlapping loops. It is the second quickest and second most efficient step.

FIG. 16 shows a schematic of the third step in the protocol, which connects the third-nearest neighbors. This step requires 3 KEs to complete and is not as efficient as the first two steps in the protocol but still has simultaneous loops in the case of N=8.

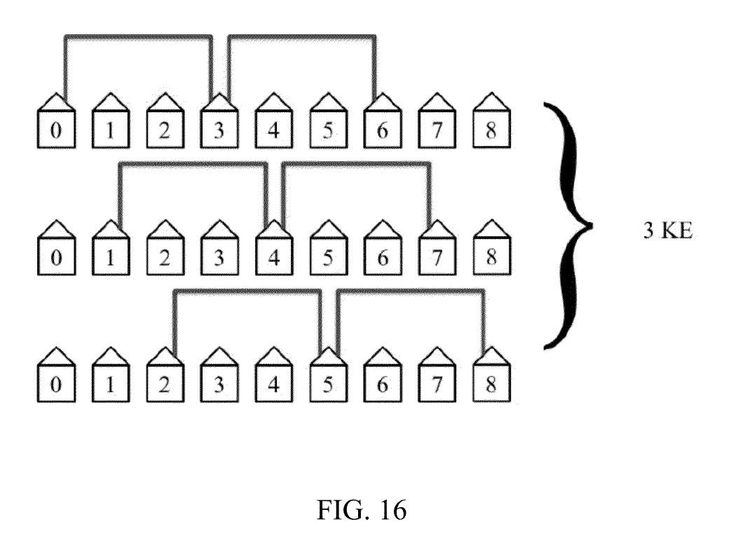

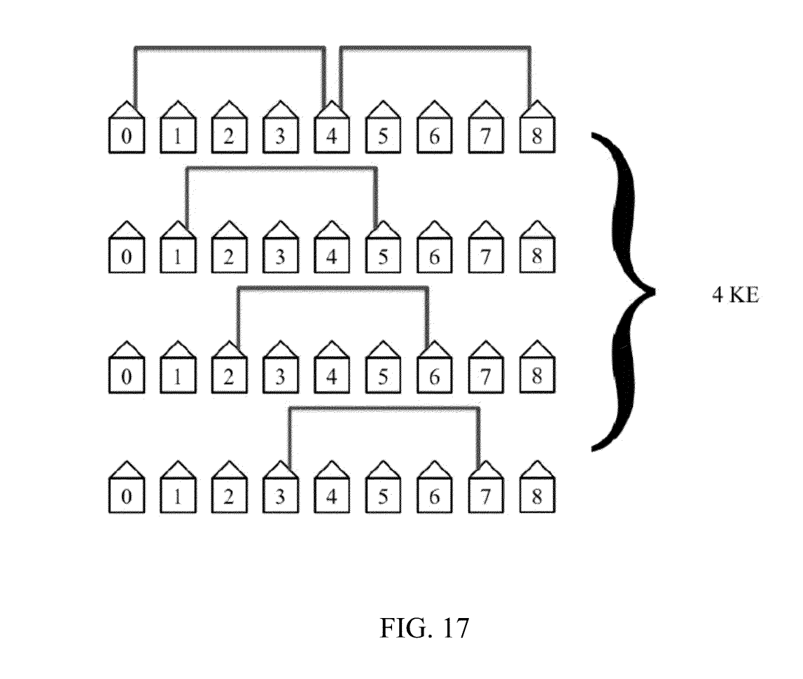

FIG. 17 shows a schematic of the fourth step in the protocol, which connects the fourth-nearest neighbors. This is at the midpoint for the case of N=8 and is the slowest and least efficient step in the protocol. The midpoint is defined when the distance between the hosts exchanging keys is equal to half the length of the network. This step requires 4 KEs to complete. The slowest and least efficient steps occur at the midpoint of the protocol.

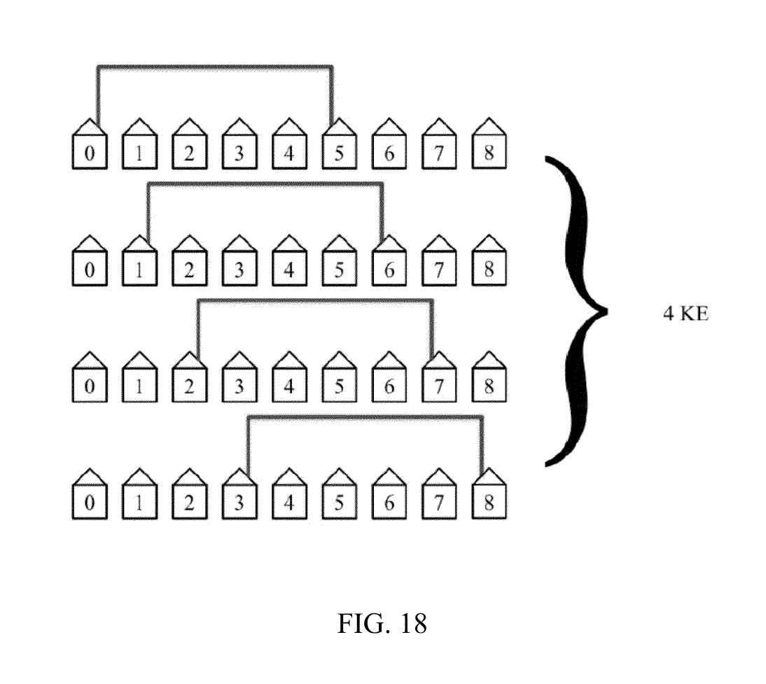

FIG. 18 shows a schematic of the fifth step in the protocol, which connects the fifth-nearest neighbors. This step is not efficient since simultaneous non-overlapping loops with disconnected hosts cannot occur. It requires 4 KEs to complete.

FIG. 19 shows a schematic of the sixth step in the protocol, which connects the sixth-nearest neighbors. This step requires only 3 KEs since it is the third-to-last step and there are only three possibilities at this distance in the case of a network of size N=8.

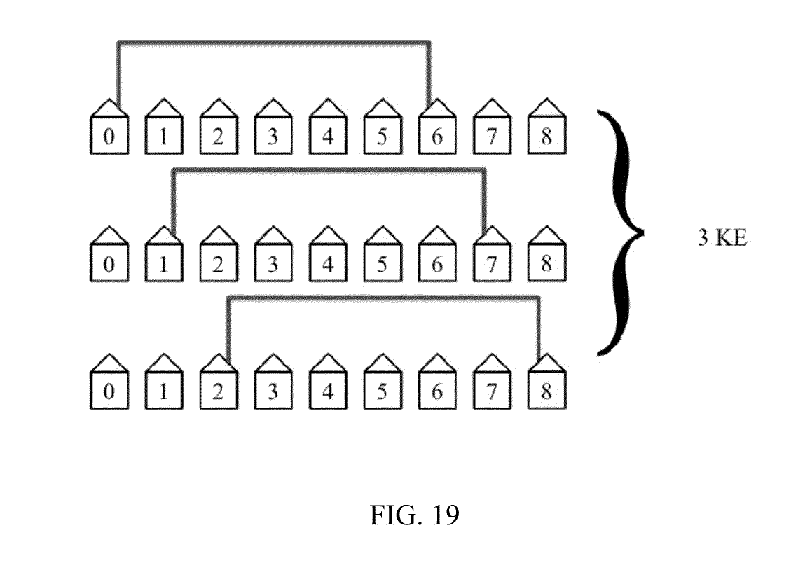

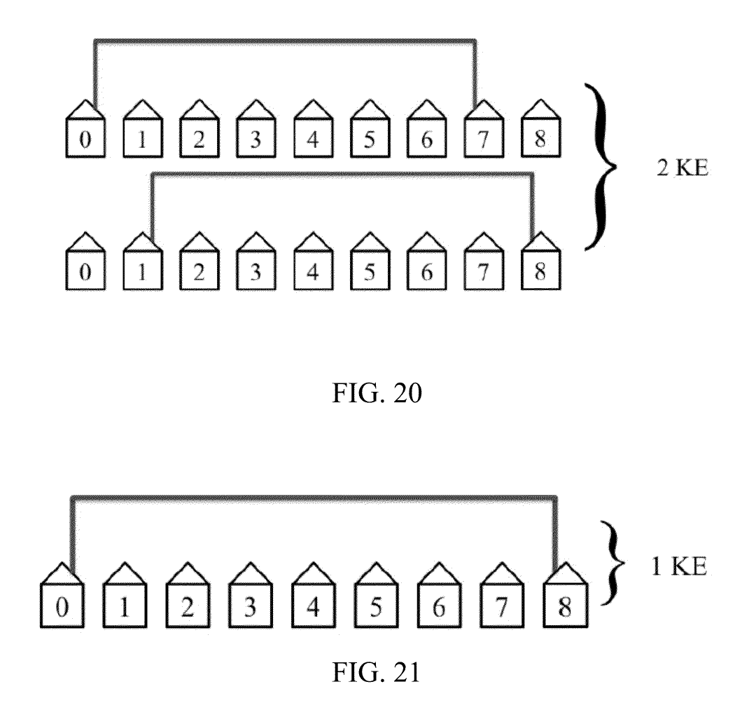

FIG. 20 shows a schematic of the seventh step, which connects the seventh-nearest neighbors. This step is not efficient but only requires 2 KEs since there are only two such pairs of hosts.

FIG. 21 shows a schematic of the eighth step, which connects the eighth-nearest neighbors. This step is not efficient but only requires 1 KE since there is only one pair of hosts that are eight hosts apart.

A pattern emerges for N being even. The KEs by step are 1 KE, 2 KE, 3 KE, 4 KE, 4 KE, 3 KE, 2 KE, and 1 KE. This is essentially Gauss's counting technique up to N/2 and back. The total number of KEs needed is 1KE+2KE+3KE+4KE+4KE+3KE+2KE+1KE=20KE. The time needed to connect the entire network will take 20 KEs (e.g., approximately 40 seconds if Bₖₗⱼₙ is 10 kHz and if the key is 100 bits long).

The speed or time requirement of the protocol for a network of size N with N being even between the first and last host is ((N²)/4+N/2) KEs and can be derived as follows.

With N=8 the pattern in this case is;

$$\frac{{N}^{2}}{4} + \frac{N}{2} = 20 K E . \qquad ( 9 )$$

Since N is even, it can be expressed as;

N=2n. (10)

To find the midpoint, n can be solved for and expressed in terms of N, giving the following;

$$\frac{N}{2} = n . \qquad ( 11 )$$

The general pattern when N is even has the following form;

$$1 + 2 + … + n + n + … + 2 + 1 = \frac{{N}^{2}}{4} + \frac{N}{2} . \qquad ( 12 )$$

Expressing n in terms of N gives;

$$1 + 2 + … + \frac{N}{2} + \frac{N}{2} + … + 2 + 1 = \frac{{N}^{2}}{4} + \frac{N}{2} . \qquad ( 13 )$$

It is know from Gauss's counting method that,

$$1 + 2 + … + N = \frac{N ( N + 1 )}{2} . \qquad ( 14 )$$

In the pattern, Gauss's counting method can be used twice to find the sum as follows.

$$\begin{matrix}\underbrace{1 + 2 + … + \frac{N}{2}}_{\frac{( \frac{N}{2} ) ( \frac{N}{2} + 1 )}{2}} + \underbrace{\frac{N}{2} + … + 2 + 1}_{\frac{( \frac{N}{2} ) ( \frac{N}{2} + 1 )}{2}} = \frac{{N}^{2}}{4} + \frac{N}{2} . & ( 15 ) \\ \frac{\frac{N}{2} ( \frac{N}{2} + 1 )}{2} + \frac{\frac{N}{2} ( \frac{N}{2} + 1 )}{2} = \frac{{N}^{2}}{4} + \frac{N}{2} . & ( 16 )\end{matrix}$$

This simplifies to

$$( \frac{N}{2} ) ( \frac{N}{2} + 1 ) = \frac{{N}^{2}}{4} + \frac{N}{2} . \qquad ( 17 )$$

Thus, the speed of the network is proportional to (N²)/4 with N being the size of the network and even.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein (including those in the “References” section) are incorporated by reference in their entirety, including all figures and tables, to the extent they are not inconsistent with the explicit teachings of this specification.

### REFERENCES

Engleman E, Robertson J (2013) Obama to share cybersecurity priorities with congress; http://www.bloomberg.com/news/2013-02-27/obama-to-share-cybersecurity-priorities-with-congress.html
Amin S M, Wollenberg B F (2008) Toward a smart grid. IEEE Power Energy Mag. 3: 114-122.
Kezunovic M (2011) Smart Fault Location for Smart Grids. IEEE Trans. Smart Grid 2: 11-22.
McDaniel P, McLaughlin S (2009) Security and privacy challenges in the smart Grid. IEEE Security & Privacy vol. 7: 75-77.
Kundur D, Feng X, Mashayekh S, Liu S, Zourntos T, Butler-Perry K L (2011) Towards modeling the impact of cyber attacks on a smart grid. Int. J. Security and Networks 6: 2-13.
Liang Y, Poor H V, Shamai S (2008) Information theoretic security. Foundations Trends, Commun. Inform. Theory 5: 355-580. doi: 10.1561/0100000036.
Yuen H P (2012) On the Foundations of Quantum Key Distribution—Reply to Renner and Beyond. manuscript http://arxiv.org/abs/1210.2804.
Gerhardt I, Liu Q, Lamas-Linares A, Skaar J, Kurtsiefer C, Makarov V (2011) Full-field implementation of a perfect eavesdropper on a quantum cryptography system. Nature Communications 2. doi:10.1038/ncomms1348.
Lydersen L, Wiechers C, Wittmann C, Elser D, Skaar J, Makarov V (2010) Hacking commercial quantum cryptography systems by tailored bright illumination. Nature Photonics 4: 686-689. doi: 10.1038/nphoton.2010.214.
Gerhardt I, Liu Q, Lamas-Linares A, Skaar J, Scarani V, Makarov V, Kurtsiefer C (2011) Experimentally faking the violation of Bell's inequalities. Physical Review Letters 107. doi: 10.1103/PhysRevLett.107.170404.
Makarov V, Skaar J (2008) Fakes states attack using detector efficiency mismatch on SARG04, phase-time, DPSK, and Ekert protocols. Quantum Information & Computation 8: 622-635.
Wiechers C, Lydersen L, Wittmann C, Elser D, Skaar J, Marquardt C, Makarov V, Leuchs G (2011) Aftergate attack on a quantum cryptosystem. New Journal of Physics 13. doi: 10.1088/1367-2630/13/1/013043.
Lydersen L, Wiechers C, Wittmann C, Elser D, Skaar J, Makarov V (2010) Thermal blinding of gated detectors in quantum cryptography. Optics Express 18: 27938-27954. doi: 10.1364/oe.18.027938.
Jain N, Wittmann C, Lydersen L, Wiechers C, Elser D, Marquardt C, Makarov V, Leuchs G (2011) Device calibration impacts security of quantum key distribution. Physical Review Letters 107. doi: 10.1103/PhysRevLett.107.11051.
Lydersen L, Skaar J, Makarov V (2011) Tailored bright illumination attack on distributed-phase-reference protocols. Journal of Modern Optics 58: 680-685. doi: 10.1080/09500340.2011.565889.
Lydersen L, Akhlaghi M K, Majedi A H, Skaar J, Makarov V (2011) Controlling a superconducting nanowire single-photon detector using tailored bright illumination. New Journal of Physics 13. doi: 10.1088/1367-2630/13/11/113042.
Lydersen L, Makarov V, Skaar J (2011) Comment on “Resilience of gated avalanche photodiodes against bright illumination attacks in quantum cryptography” Appl. Phys. Lett. 98, 231104 (2011). Applied Physics Letters 99. doi: 10.1063/1.3658806.
Sauge S, Lydersen L, Anisimov A, Skaar J, Makarov V (2011) Controlling an actively-quenched single photon detector with bright light. Optics Express 19: 23590-23600.
Lydersen L, Jain N, Wittmann C, Maroy O, Skaar J, Marquardt C, Makarov V, Leuchs G (2011) Superlinear threshold detectors in quantum cryptography. Physical Review A 84. doi: 10.1103/PhysRevA.84.032320.
Lydersen L, Wiechers C, Wittmann C, Elser D, Skaar J, Makarov V (2010) Avoiding the blinding attack in QKD reply. Nature Photonics 4: 801-801. doi: 10.1038/nphoton.2010.278.
Makarov V (2009) Controlling passively quenched single photon detectors by bright light. New Journal of Physics 11. doi: 10.1088/1367-2630/11/6/065003.
Kish L B (2006) Totally secure classical communication utilizing Johnson (-like) noise and Kirchoff s law. Physics Letters A 352: 178-182. doi: 10.1016/j.physleta.2005.11.062.
Kish L B (2006) Protection against the man-in the-middle-attack for the Kirchhoff-loop-Johnson(-like)-noise cipher and expansion by voltage-based security. Fluctuation and Noise Letters 6: L57-L63. doi: 10.1142/s0219477506003148.
Mingesz R, Kish L B, Gingl Z, Granqvist C G, Wen H, Peper F, Eubanks T, Schmera G (2013) Unconditional security by the laws of classical physics. Metrology and Measurement Systems 20:3-16; (open access) http://www.metrology.pg.gda.pl/full/2013/M&MS_{—}2013_{—}003.pdf
Mingesz R, Gingl Z, Kish L B (2008) Johnson(-like)-Noise-Kirchhoff-loop based secure classical communicator characteristics, for ranges of two to two thousand kilometers, via model-line. Physics Letters A 372: 978-984. doi: 10.1016/j.physleta.2007.67.086.
Kish L B, Saidi O (2008) Unconditionally secure computers, algorithms and hardware, such as memories, processors, keyboards, flash and hard drives. Fluctuation and Noise Letters 8: L95-L98. doi: 10.1142/s0219477508004362.
Kish L B, Peper F (2012) Information networks secured by the laws of physics. Ieice Transactions on Communications. E95B: 1501-1507. doi: 10.1587/transcom.E95.B.1501.
Kish L B, Mingez R (2006) Totally secure classical networks with multipoint telecloning (teleportation) of classical bits through loops with Johnson-like noise. Fluctuation and noise letters 6: L447-L447. doi: 10.1142/s0219477506003628.
Balog R S, Krein P T (2013) Coupled Inductor Filters: A Basic Filter Building Block. IEEE Transactions on Power Electronics 28: 537-546.
Kim S, Enjeti P N (2002) A new hybrid active power filter (APF) topology. IEEE Transactions on Power Electronics 17: 48-54.
Kish L B (2013) Enhanced secure key exchange systems based on the Johnson-noise scheme; Metrology & Measurement Systems XX:191-204; open access: http://www.degruyter.com/view/j/mms.2013.20.issue-2/mms-2013-0017.xml?format=INT
Kish L. B., Phys. Lett. A 352 (2006) 178-182.
Kish L. B. and Granqvist C. G., Quantum Inf. Process., (2014), in press, doi: 10.1007/s11128-014-0729-7.
Mingesz R., Gingl Z. and Kish L. B., Phys. Lett. A, 372 (2008) 978-984.
Gingl Z. and Mingesz R., PLoS ONE, 9 (2014) e96109.
Mingesz R., Vadai G. and Gingl Z., Fluct. Noise Lett. (2014), in press, arXiv:1405.1196.
Bergou J., interviewed in: CHO A., Science 309 (2005) 2148.
Scheuer J. and Yariv A., Phys. Lett. A, 359 (2006) 737-740.
Kish L. B. and Scheuer J., Phys. Lett. A, 374 (2010) 2140-2142.
Kish L. B., Metrol. Meas. Syst., 20 (2013) 191-204. DOI: 10.2478/mms-2013-0017.
Mingesz R., Kish L. B., Gingl Z., Granqvist C. G., Wen H., Peper F., Eubanks T. and Schmera G., Metrol. Meas. Syst. 20 (2013) 3-16. doi: 10.2478/mms-2013-0001.
Kish L. B., Mingesz R., Gingl Z. and Granqvist C. G., Metrol. Meas. Syst. 19 (2012) 653-658.
Horvath T., Kish L. B. and Scheuer J., EPL 94 (2011) 28002.
Hao F., IEE Proc. Inform. Soc. 153 (2006) 141-142.
Smulko J., Fluct. Noise Lett. (2014), in press.
Saez Y., Kish L. B., Mingesz R., Gingl Z. and Granqvist C. G., J. Comput. Electron. 13 (2014) 271-277.
Kish L. B., Granqvist C. G., “Elimination of a Second-Law-attack, and all cable-resistance-based attacks, in the Kirchhoff-law-Johnson-noise (KLJN) secure key exchange system”, Jun. 27, 2014 (http://arxiv.org/ftp/arxiv/papers/1406/1406.5179.pdf)
Kish L. B. and Granqvist C. G., Quantum Inf Process 13 (2014) 2213-2219.

What is claimed is:

1. A Kirchhoff-Law-Johnson-(like)-Noise (KLJN) system for secure key distribution, comprising:
a wired network; and
a plurality of hosts connected to each other on the wired network,
wherein each host is connected to every other host by a continuous wired path capable of transmitting electrical current,
wherein each host of the plurality of hosts comprises a first resistor and is configured to produce a first-resistor enhanced Johnson noise voltage when the first resistor is connected to a voltage source,
wherein each host of the plurality of hosts further comprises a second resistor and is further configured to produce a second-resistor enhanced Johnson noise voltage when the second resistor is connected to a voltage source,
wherein the resistance value of the first resistor of each host is identical to that of all other hosts of the plurality of hosts,
wherein the resistance value of the second resistor of each host is the identical to that of all other hosts of the plurality of hosts, and
wherein the plurality of hosts comprises at least three hosts.

2. The system according to claim 1, wherein each host further comprises a filter box.

3. The system according to claim 2, wherein the filter box comprises:
a first KLJN filter for KLJN key exchange; and
a main signal filter for supplying a main signal of the network to the host having the filter box.

4. The system according to claim 3, wherein at least one of the first KLJN filter and the main signal filter is a low pass filter.

5. The system according to claim 3, wherein the first KLJN filter is connected to the first and second resistors, such that the first KLJN filter is connected between all other hosts and the first and second resistors of the host having the filter box.

6. The system according to claim 5, wherein each host comprises a third resistor, and wherein the main signal filter is connected to the third resistor of the host having the filter box such that the main signal filter is connected between all other hosts and the third resistor of the host having the filter box.

7. The system according to claim 5, wherein the KLJN filter comprises a first sub-filter and a second sub-filter,
wherein, when open, the first sub-filter permits a signal to pass through the KLJN filter without reaching the first and second resistors,
wherein, when open, the second sub-filter permits a signal to reach the first and second resistors,
wherein the KLJN filter is configured such that, in an inactive state, the first sub-filter is open to Johnson noise and the second sub-filter is closed to Johnson noise, and
wherein the KLJN filter is configured such that, in an active state, the first sub-filter is closed to Johnson noise and the second sub-filter is open to Johnson noise.

8. The system according to claim 1, wherein the wired network is an existing infrastructure network.

9. The system according to claim 1, wherein the wired network is a smart power grid.

10. The system according to claim 3, wherein the wired network is a smart power grid, and wherein the main signal filter is a power filter for supplying power to the host having the filter box.

11. A Kirchhoff-Law-Johnson-(like)-Noise (KLJN) method for secure key distribution using a system, wherein the system comprises:
a wired network; and
a plurality of hosts connected to each other on the wired network,
wherein each host is connected to every other host by a continuous wired path capable of transmitting electrical current,
wherein each host of the plurality of hosts comprises a first resistor and a second resistor,
wherein the resistance value of the first resistor of each host is identical to that of all other hosts of the plurality of hosts,
wherein the resistance value of the second resistor of each host is the identical to that of all other hosts of the plurality of hosts,
wherein the plurality of hosts comprises at least three hosts,
wherein the method comprises:
connecting, to a voltage source, exactly one of the first resistor or the second resistor of a first host of the plurality of hosts, thereby producing a first-host enhanced Johnson noise voltage, which is transmitted to a second host of the plurality of hosts;
connecting, to a voltage source, exactly one of the first resistor or the second resistor of the second host, thereby producing a second-host enhanced Johnson noise voltage, which is transmitted to the first host; and
connecting, to a voltage source, exactly one of the first resistor or the second resistor of a third host of the plurality of hosts, thereby producing a third-host enhanced Johnson noise voltage, which is transmitted to the first host.

12. The method according to claim 11, wherein each host further comprises a filter box.

13. The method according to claim 12, wherein the filter box comprises:
a first KLJN filter for KLJN key exchange; and
a main signal filter for supplying a main signal of the network to the host having the filter box.

14. The method according to claim 13, wherein at least one of the first KLJN filter and the main signal filter is a low pass filter.

15. The method according to claim 13, wherein the first KLJN filter is connected to the first and second resistors, such that the first KLJN filter is connected between all other hosts and the first and second resistors of the host having the filter box.

16. The method according to claim 15, wherein each host comprises a third resistor, and wherein the main signal filter is connected to the third resistor of the host having the filter box such that the main signal filter is connected between all other hosts and the third resistor of the host having the filter box.

17. The method according to claim 15, wherein the KLJN filter comprises a first sub-filter and a second sub-filter,
wherein, when open, the first sub-filter permits a signal to pass through the KLJN filter without reaching the first and second resistors,
wherein, when open, the second sub-filter permits a signal to reach the first and second resistors,
and wherein the method further comprises:
placing the KLJN filter in an inactive state by opening the first sub-filter to Johnson noise and closing the second sub-filter to Johnson noise; and
placing the wherein the KLJN filter is in an active state, when the host having the KLJN filter is receiving a key, by closing the first sub-filter to Johnson noise and opening the second sub-filter to Johnson noise.

18. The method according to claim 11, wherein the wired network is an existing infrastructure network.

19. The method according to claim 11, wherein the wired network is a smart power grid.

20. The method according to claim 13, wherein the wired network is a smart power grid, and wherein the main signal filter is a power filter for supplying power to the host having the filter box.
